(19) United States
(12) Patent Application Publication
(10) Pub. No.: US 2016/0300044 A1
(43) Pub. Date: Oct. 13, 2016

(54) ANTI-DEBUGGING METHOD

(71) Applicant: INKA ENTWORKS, INC., Seoul (KR)

(72) Inventors: Jae Min NAM, Seoul (KR); Jung Geun PARK, Gyeonggi-do (KR); Jun Ho HONG, Gyeonggi-do (KR); Jun Seok OH, Seoul (KR); Jung Soo KIM, Seoul (KR)

(21) Appl. No.: 15/036,535

(22) PCT Filed: Nov. 3, 2014
(86) PCT No.: PCT/KR2014/010446

§ 371 Date: May 13, 2016

(30) Foreign Application Priority Data
Nov. 14, 2013 (KR) 10-2013-0138644

(51) Int. Cl. G06F 21/14; G06F 11/36; G06F 21/12

(52) U.S. Cl. CPC G06F 21/14; G06F 21/125; G06F 11/366; G06F 2221/0737; G06F 2221/0735

(57) ABSTRACT

Disclosed is an anti-debugging device. In a method for performing anti-debugging by an anti-debugging device, the method comprises creating a child process; monitoring the state of a parent process by the child process; and monitoring the state of the child process by the parent process.

### BACKGROUND OF THE INVENTION

1. Field of the Invention

The present invention relates to an anti-debugging method for monitoring a process state.

2. Description of the Related Art

The following contents provide only background information related to the present embodiment but does not configure related art.

Hacking starts by analyzing a program. The program may be substantially cracked only when understanding logic through program analysis. There are two methods for analyzing program. One is a static analysis method and the other is a dynamic analysis method.

The static analysis method analyzes only a file itself without running a program file. The static analysis method analyzes a binary program file by using a disassembly tool or a decompile tool. The above tools may convert the binary program file into an assembly language or other high-level language form. The logic of program may be understood by analyzing the converted assembly language and the like.

Unlike the static analysis method, a dynamic analysis method runs a program and analyzes program by viewing the flow of a running code at a debugging tool, a memory state, and the register state of a program. Since an analysis method which uses a debugger analyzes the program while viewing the flow of the running code, it is easy to understand the logic of program and it is possible to determine the parts on which the running code is performed and the parts on which the running code is not performed. Further, during the analysis, a value stored in memory or register may be changed.

With the analysis method which uses debugging, it is possible to change data in real time during the logical flow or the running of program. Since it has a wider analysis range than that of the static analysis method, it is widely used.

Anti-debugging is a technique which prevents analysis by hindering debugging. If debugging occurs, the analysis may be prevented by using various methods such as a method for terminating a corresponding debugger program or a method for generating errors. An anti-debugging technology according to the related art mainly confirms whether a debugging program is run and stops running a debugging target program. However, according to the above method, when an unexpected situation such as a new debugging program occurs, it is difficult to deal with the unexpected situation. Further, an anti-debugging technique limited to a specific operating system or processor has been used. For example, the Windows operating system uses a method for determining whether performing debugging by using IsDebuggerPresent ( ) and CheckRemoteDebuggerPresent ( ) of Application Program Interface (API) and a NtGlobeFlag value provided by the Windows. However, since Linux, Unix, OS X, and the like do not provide the same or similar API, the above method cannot be used.

### SUMMARY OF THE INVENTION

The present embodiment provides an anti-debugging method for monitoring a process state.

According to one aspect of this embodiment, in a method for performing anti-debugging by using an anti-debugging device, the method comprises creating a child process; monitoring the state of a parent process by the child process; and monitoring the state of the child process by the parent process.

According to another aspect of this embodiment, in an anti-debugging device, the device comprises a parent process including a child process creating unit configured to create a child process and a child process monitoring unit configured to monitor the state of the child process; and a child process including a parent process monitoring unit configured to monitor the state of the parent process.

As described above, according to the present embodiment, a parent process monitors the state of a child process in real time and the child process monitors the state of the parent process in real time. When the parent process or the child process is changed to a debugging state, that is, a traced or stopped state, a program may be prevented from running in the debugging state any longer by immediately forcing the parent process and the child process to be terminated.

Further, according to the present embodiment, a program may be protected from the attack of a memory cheat program extensively used for hacking games and the like. Since the memory cheat program is performed after a state of the attack target program is changed to a traced or stopped state, according to an embodiment of the present invention, it is checked whether a process is in a traced state. If it is confirmed that the process is in a traced state, the program can be protected from the attack of the memory cheat program by terminating the process.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating the configuration of a computer for providing anti-debugging.

FIG. 2 is an exemplary diagram illustrating the configuration of a process control block;

FIG. 3 is an exemplary diagram illustrating the state transition procedure of a process;

FIG. 4A is a flowchart illustrating a method for monitoring a child process by a parent process according to the present embodiment;

FIG. 4B is a flowchart illustrating a method for monitoring a parent process by a child process according to the present embodiment.

FIG. 5 is an exemplary diagram illustrating a state that the parent process and the child process monitor each other.

FIG. 6 is a block diagram illustrating the configuration of an anti-debugging device according to the present embodiment.

### DETAILED DESCRIPTION OF EXEMPLARY EMBODIMENTS

Exemplary embodiments of the present invention are described with reference to the accompanying drawings in detail. A technical scope of the present invention is applicable to various systems, and is not limited to a specific operating system or hardware.

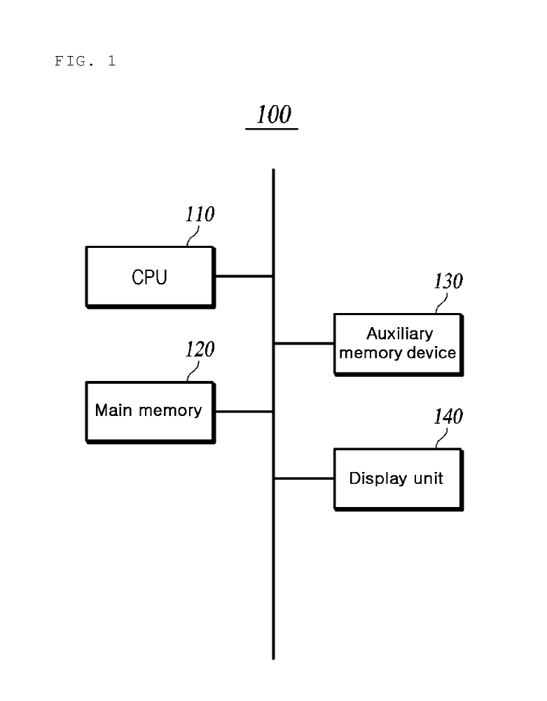

FIG. 1 is a block diagram illustrating the configuration of a computer for providing anti-debugging.

FIG. 1 illustrates an example of a computer for providing anti-debugging to mutually monitor a process state whether a parent process and a child process are debugged. When a program stored in an auxiliary memory 130 is run, the program is loaded into a main memory 120 and is processed by a central processing unit (CPU) 110 and the CPU 100 displays the processed result on a display unit 140. When the program is run, a child process having the same shape as that of the program is created (forked), and the program itself becomes a parent process of the child process. The parent process and the child process may monitor a process state of the other party between each other to prevent the program from being analyzed due to debugging.

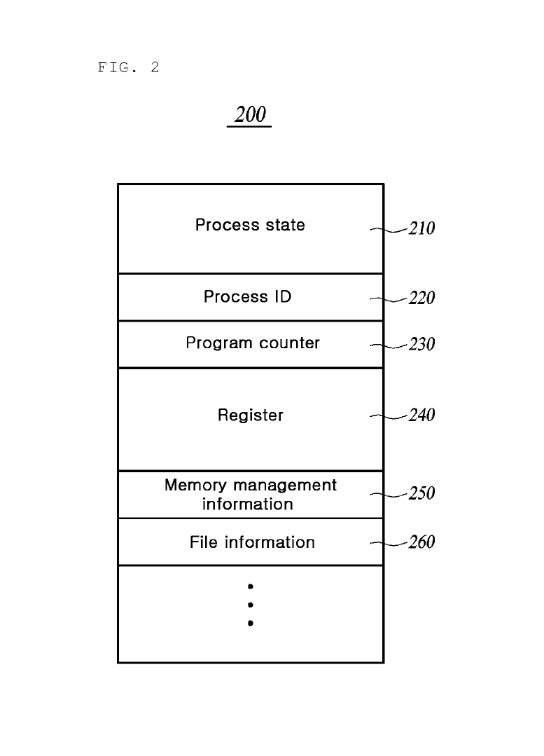

FIG. 2 is an exemplary diagram illustrating the configuration of a process control block.

When a process is created by running a program, operating systems store necessary information therein in order to manage the process. A block for storing the necessary information is referred to as a process control block (PCB) 200. However, the PCB 200 may be called another name according to an operating system. The PCB 200 may include information such as a process state 210, a process identifier (ID) 220, a program counter 230, a register 240, memory management information 250, and file information 260. Information indicating a process state such as a created state, a ready state, a running state, a waiting state, a terminated state, and a traced state is stored in the process state 210. ID information for identifying a running process in a system is stored in the process ID 220. Address information of a next command which the process will run is stored in the program counter 230. A register value related to an operation of a CPU is stored in a register 240. Information on an address space of the process is stored in the memory management information 250. Information on a file and an input/output device which the process opens for input/output is stored in the file information 260.

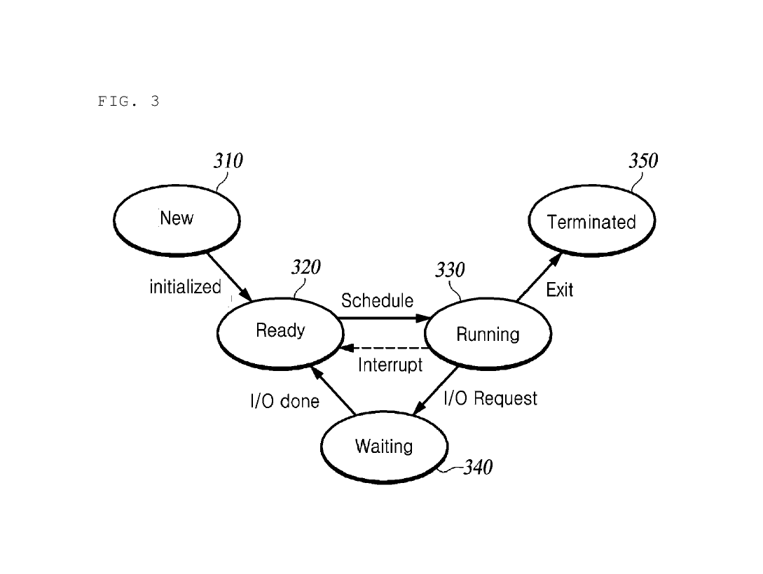

FIG. 3 is an exemplary diagram illustrating the state transition procedure of a process.

FIG. 3 is an exemplary diagram illustrating the transition procedure of process state information included in the PCB of FIG. 2 when the process is created. When the program stored in the auxiliary memory 130 is run and loaded into the main memory 120, the process is created and initialized. At this time, a process state value of the PCB 200 is set as a new state or a created state 310. However, the process is created but may not be run by an operating system. In order to run the process, the process should wait for assignment of CPU in a Queue in a Kernel of the operating system. When the process reaches the above state, the process state value becomes a ready state 320. When the process is in its turn during waiting in the Queue, the process is assigned CPU to run. At this time, the process state value becomes a running state 330. If a situation requiring input/output (I/O) occurs under the running of the process, the process sends an I/O request to a system and the process becomes a waiting state 340. When the input/output is completed in the waiting state 340, the process becomes the ready state 320 to run again. When the process is in its turn, the process is assigned CPU to run, so that the process state becomes a running state 330. When the process completes its operation, the process returns all resources thereof to the system and is terminated. When the process returns the resources thereof to the system for termination, it is in a terminated state 350.

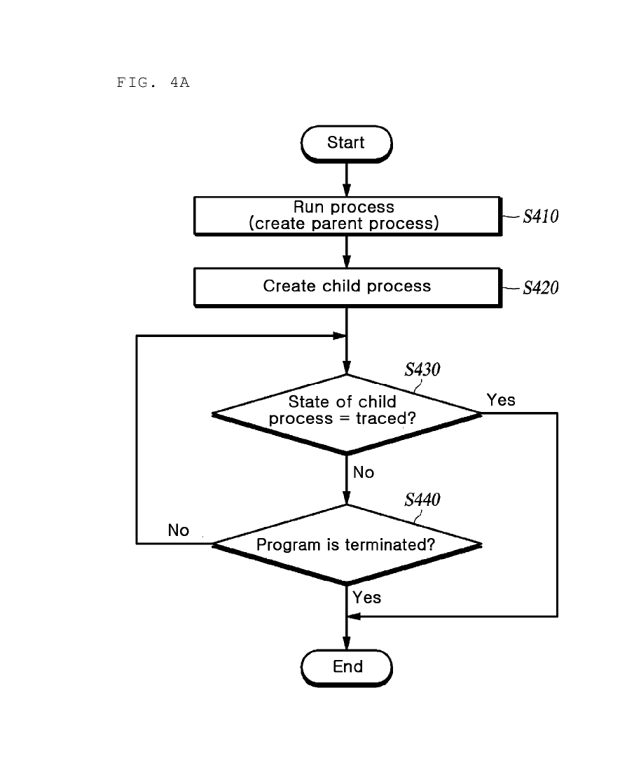

Before the process is terminated, if a debugger is attached for debugging the process in one state, the process state is transited to a traced or stopped state. Further, the program may be run even in the debugger. At this time, the created process becomes the traced state. The technical concept of the present invention discriminates a debugging state by understanding the above state transition of the process. When the debugging state is discriminated, the running of the process is stopped to prevent the program from being analyzed through debugging. The above will be described in detail with reference to FIG. 4A and FIG. 4B.

FIG. 4A is a flowchart illustrating a method for monitoring a child process by a parent process according to the present embodiment.

A program is run by loading into a main memory 120, so that a process is created (S410). The created process creates a child process which shares a program code but has a separate address space (S420). At this time, the above process creating the child process is referred to as a parent process. The parent process continuously checks whether the state of the child process is a traced or stopped state (S430). If the program is not terminated (S440), the step of checking the child process by the parent process is continuously performed. A debugger such as a Gnu Debugger (GDB) may debug a program by running the program in the debugger or attaching to a running process. Further, a memory cheat program also changes the program state to a traced state and then changes a memory value which is at the desired location of the memory cheat program. If the state of the child process is changed to the traced state, the child process may determine that the program is analyzed by a dynamic analysis tool such as a debugger or a memory cheat program. Since a process state is changed to the traced state when the process is debugged by using a debugger, the traced state of the process may be determined to be a debugging state. The traced state is a stopped state of the process. When a debugger such as a GDB is attached to the process in the stopped state of the program or the debugger sets a break point to debug the process, the traced state appears. Accordingly, the traced state may be determined as a debugging state.

As described above, when the process is in the traced state, the process may immediately be stopped to prevent the program from being analyzed. In addition, the parent process monitors whether the child process is terminated. If the child process is terminated, the parent process also is terminated.

FIG. 4B is a flowchart illustrating a method for monitoring a parent process by a child process according to the present embodiment.

A child process is created by a parent process (S450). The created child process continuously checks whether the state of the parent process is a traced state (S460). If the state of the parent process is changed to the traced state, the child process may determine that a program of the parent process is analyzed by a dynamic analysis tool such as a debugger or a memory cheat program. If the program is not terminated (S470), the procedure of monitoring the parent process by the child process is continuously performed. If it is determined that the program is analyzed, in the same manner as in FIG. 4A, the parent process is terminated to prevent the program from being analyzed. Moreover, the child process monitors whether the parent process is terminated. If it is determined that the parent process is terminated, the child process also is terminated.

In case of monitoring the process state only by the parent process, the parent process is in a stopped state in which any operation may not be performed if the parent process itself is changed to the traced state, thus the parent process and the child process should monitor each other. The state monitoring performed by only the parent process may not monitor the traced state of the parent process itself. According to the present invention, if a parent process creates a child process to monitor each other, when one of two processes is changed to the traced state, the other process may monitor the changed process to stop the process.

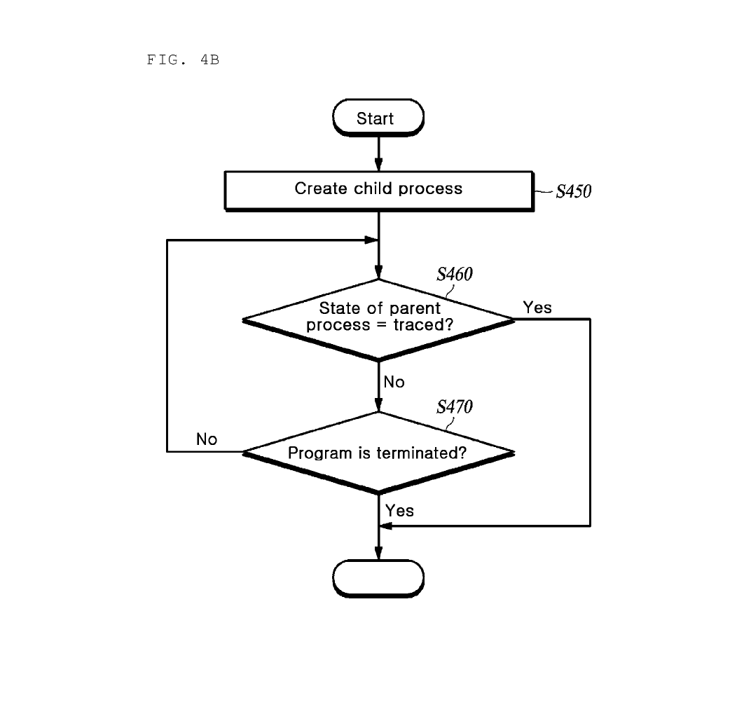

FIG. 5 is an exemplary diagram illustrating a state that a parent process and a child process monitor each other.

FIG. 5 illustrates an example of a state in which a parent process 510 is created by running a program and the parent process 510 creates (forks) a child process 520, and then the parent process 510 monitors the state of the child process 520 and the child process 520 monitors the state of the parent process 510.

The parent process 510 and the child process 520 under running into the main memory 120 mutually monitor each other always in pairs. If one of the parent process 510 and the child process 520 is terminated, the other process is also terminated and if one of the parent process 510 and the child process 520 is changed to a traced state, the other process terminates the changed process and also terminates itself to prevent the program from being analyzed.

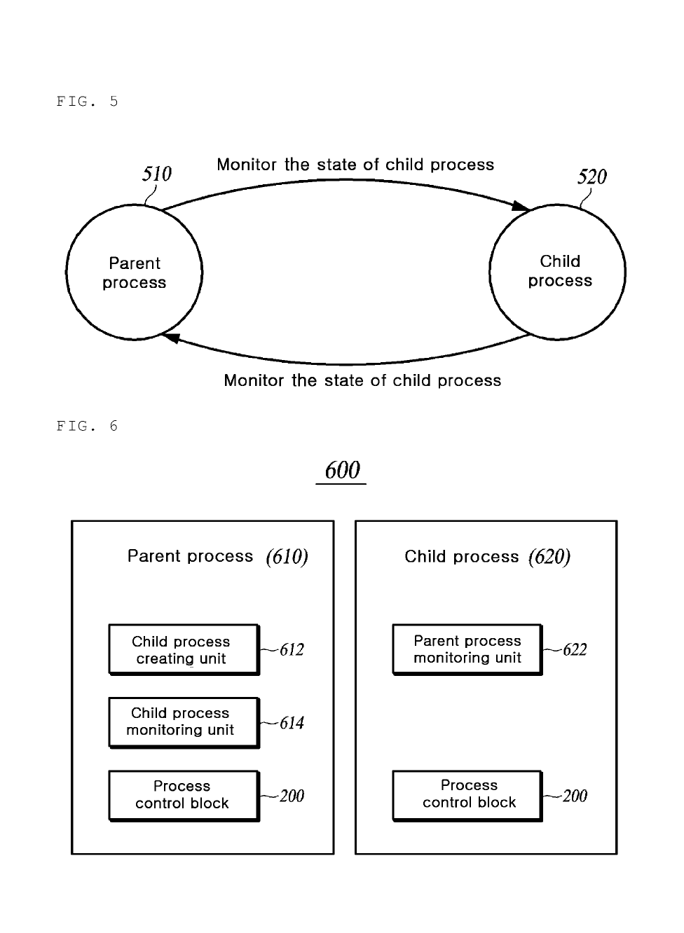

FIG. 6 is a block diagram illustrating the configuration of an anti-debugging device according to the present embodiment.

The anti-debugging device 600 includes a parent process 610 and a child process 620. The parent process 610 includes a child process creating unit 612 configured to create the child process 620, a child process monitoring unit 614 configured to monitor a process state of the created child process 620, and a process control block 200 configured to store information for managing the parent process including parent process state information.

The child process creating unit 612 may create a child process monitoring unit 614 as a separate thread for monitoring the child process 620 after creating the child process 620. The child process monitoring unit 614 continuously checks whether the process state information of the process control block 200 inside the child process 620 is in a traced state. As the result of check, if it is confirmed the process state information of the process control block 200 is in a traced state, the program is determined to be analyzed by a debugger or a memory cheat program, so that the parent process 610 and the child process 620 are terminated. In addition, when the child process 620 does not exist, the parent process 610 is terminated. Moreover, the child process also may create a separate threshold to monitor the parent process.

The child process 620 includes a parent process monitoring unit 622 configured to monitor a process state of the parent process 610 and a process control block 200 configured to store information for managing a process including child process state information. The parent process monitoring unit 622 of the child process 620 continuously checks whether the process state of the process control block 200 of the parent process 610 is a traced state. The parent process monitoring unit 622 may be operated as a separate thread in the child process 620. As the result of check, when the state information of the process control block 200 is a traced state, the program is determined to be analyzed by a debugger or a memory cheat program, so that the parent process 610 and the child process 620 are terminated. In addition, when the parent process 610 does not exist, the child process 620 is terminated.

The anti-debugging device 600 according to embodiments of the present invention may hp a user terminal such as a personal computer (PC), a notebook computer, a tablet, a personal digital assistant (PDA), a game console, a portable multimedia player (PMP), a PlayStation Portable (PSP), a wireless communication terminal, a smart phone, TV and a media player. The anti-debugging device 600 according to embodiments of the present invention may be a server terminal such as an application server and a service server. The anti-debugging device 600 according to embodiments of the present invention may respectively refer to various devices provided with (i) a communication device such as a communication modem for performing communication with various devices or a wired/wireless communication network, (ii) a memory for storing data to execute the program, (iii) a microprocessor for performing computation and control by executing the program, and the like. In accordance with at least one embodiment, the memory may be a computer-readable recording/storage medium such as a Random Access Memory (RAM), a Read Only Memory (RPM), a flash memory, an optical disk, a magnetic disk, a solid state disk (SSD). In accordance with at least one embodiment, the microprocessor may be programmed to perform optionally at least one of operations and functions described herein. In accordance with at least one embodiment, the microprocessor may be implemented on the whole or on the part thereof by using hardware such as an application specific integrated circuit (ASIC) of a particular configuration.

The above description is simply to describe the technical concept of the embodiments by way of examples. Those skilled in the art of the embodiments may make various modifications, additions and substitutions, without departing from principles of this disclosure. Accordingly, the embodiments are intended for illustrating rather than for limiting the technical scope of this embodiment. The scope of the technical concept of the embodiments is not limited by the embodiments. The scope of the embodiment is to be interpreted by the following claims. All such modifications and variations are to be construed as being included within the scope of this embodiment.

What is claimed is:

1. A method for performing anti-debugging by an anti-debugging device, the method comprising:
creating a child process;
monitoring the state of a parent process by the child process; and
monitoring the state of the child process by the parent process.

2. The method of claim 1, wherein the monitoring of the state of a parent process comprises:
acquiring a process state value in a process control block of the parent process by the child process; and
checking whether a process state value of the parent process is in a traced or stopped state.

3. The method of claim 2, further comprising terminating the parent process and the child process when the state of the parent process is the traced state.

4. The method of claim 1, further comprising terminating the child process when the parent process is terminated.

5. The method of claim 1, wherein the monitoring of the state of the child process comprises:
acquiring a process state value in a process control block of the child process by the parent process; and
checking whether a process state value of the child process is in a traced or stopped state.

6. The method of claim 5, wherein further comprising terminating the parent process and the child process when the state of the child process is the traced state.

7. The method of claim 1, further comprising terminating the parent process when the child process is terminated.

8. An anti-debugging device comprising:
a parent process including a child process creating unit configured to create a child process and a child process monitoring unit configured to monitor the state of the child process; and
a child process including a parent process monitoring unit configured to monitor the state of the parent process.

9. The method of claim 8, wherein the parent process creates the child process monitoring unit as a separate thread.

10. The method of claim 8, wherein the child process creates the parent process monitoring unit as a separate thread.
